(19) United States
(12) Patent Application Publication
(10) Pub. No.: US 2013/0154279 A1
(43) Pub. Date: Jun. 20, 2013

(54) Wheelmill

(71) Applicant: Torek Thompkins, Winter Park, FL (US)

(72) Inventor: Torek Thompkins, Winter Park, FL (US)

(21) Appl. No.: 13/374,229

(22) Filed: Dec. 16, 2011

(51) Int. Cl. H02K 7/18

(52) U.S. Cl. 290/1 R

(57) ABSTRACT

By transferring the rotation of a vehicle wheel assembly to an electric generator motor, a vehicle may provide electricity for itself. Wheel assembly rotation will spin a wheelmill by connecting the wheelmill to a rotational surface of a vehicle wheel assembly. Electricity generated from the wheelmill can be used to supplement and recharge the power of the vehicle's electrical source, lengthen the battery life of a vehicle, and minimize battery capacity.

### BACKGROUND OF THE INVENTION

Field of the Invention

The invention relates generally to the field of windmills, watermills, and more particularly to mills that can be used for producing electricity from the wheel assembly rotation of a vehicle. This invention will allow vehicles to generate electricity by using its own wheel assembly rotation, even when there is no power being supplied by the vehicle's power source.

### BRIEF SUMMARY OF THE INVENTION

In this embodiment of the invention, a wheelmill rotates on a horizontal axis. The wheelmill is stationed on the inner surface of the vehicle wheel. As the vehicle wheel rotates, traction along the wheelmill connecting surface forces the wheelmill to rotate in conjunction.

The wheelmill is secured to the electric generator motor shaft of the electric motor that is within the vehicle. This connection keeps the wheelmill transferring rotation to the electric motor for electricity production.

### BRIEF DESCRIPTION OF THE DRAWINGS

In order to better understand the invention, reference is made to the accompanying drawing, wherein:

FIG. 1 shows an elevated view of an embodiment of the wheelmill described herein.

FIG. 2 shows an elevated view of an embodiment of the wheelmill described herein, in association with the shaft of an electric generator motor.

FIG. 3 shows an elevated view of an embodiment of the wheelmill described herein, in unison with the shaft of an electric generator motor.

FIG. 4 shows a view of an embodiment of the wheelmill described herein, in unison with the shaft of an electric generator motor, and in the direction which it connects to the vehicle wheel.

FIG. 5 shows a view of an embodiment of the wheelmill described herein, in unison with the shaft of an electric generator motor, and in contact with a vehicle wheel.

FIG. 6 shows a view of the vehicle wheel rotation yielding the rotation of an embodiment of the wheelmill, while in unison with the electric generator motor shaft.

### DETAILED DESCRIPTION OF THE INVENTION

Referring to the drawings, in which like numerals and letters refer to like components or steps.

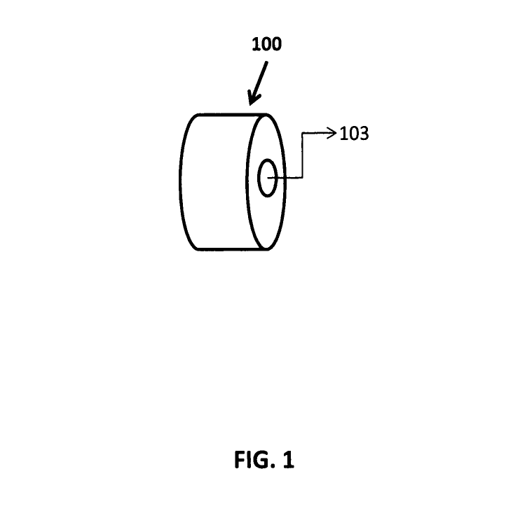

FIG. 1 is a perspective view of the exemplary embodiment of the wheelmill 100 according to the present disclosure. The exemplary embodiment of the wheelmill 100 is made of solid material. The outer surface has traction so that it may grip the inner surface wall of a vehicle wheel. Centered on the exemplary embodiment of the wheelmill's horizontal axis is a threaded hole 103.

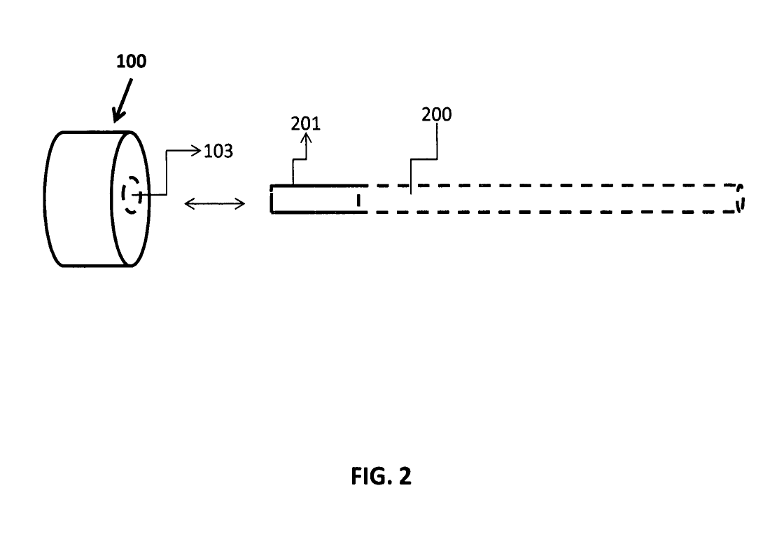

FIG. 2 is perspective of the shaft of the electric motor generator 200. A threaded end of an electric generator motor 201 connects to the exemplary embodiment of the wheelmill 100 by way of its threaded hole 103.

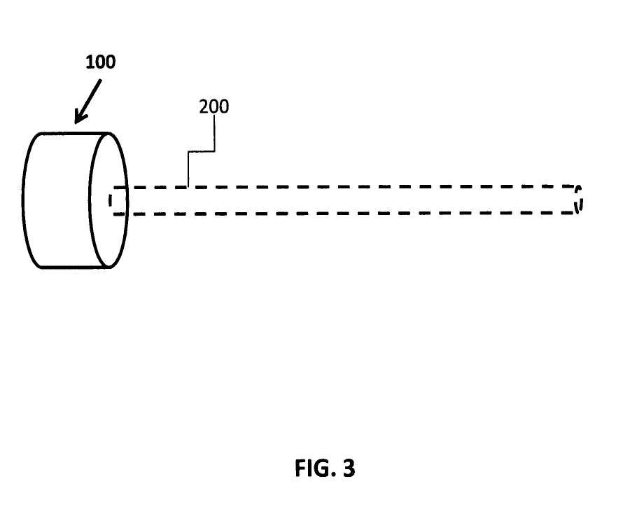

FIG. 3 is a perspective of the exemplary embodiment of the wheelmill 100 and the shaft of an electric generator motor 200, in unison after being screwed together.

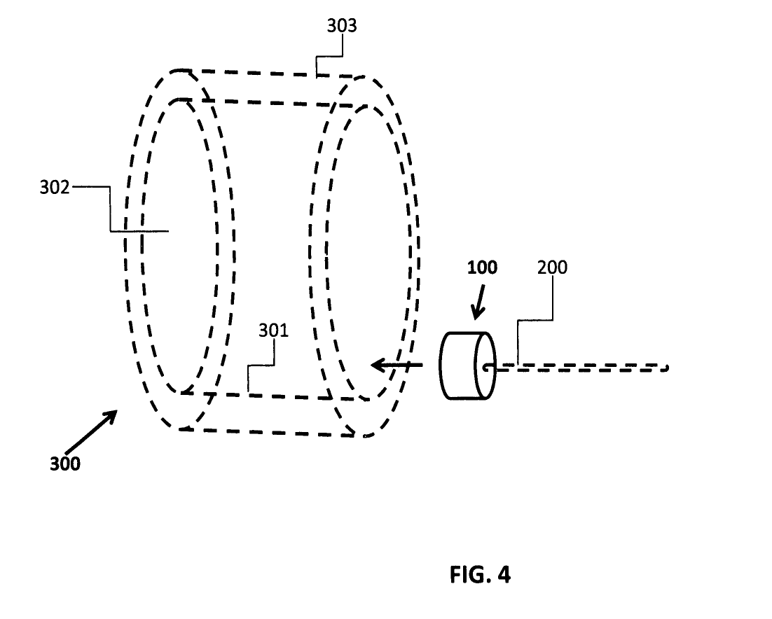

FIG. 4 is perspective of the vehicle wheel 300, its basic described surfaces herein, and how the wheelmill 100 enters and connects to the wheel. The vertical outer wall of the wheel 302 faces the exterior of a vehicle and rotates in the direction a vehicle is traveling. The outer surface of the wheel 303 is the surface of the wheel that connects to ground the vehicle travels on.

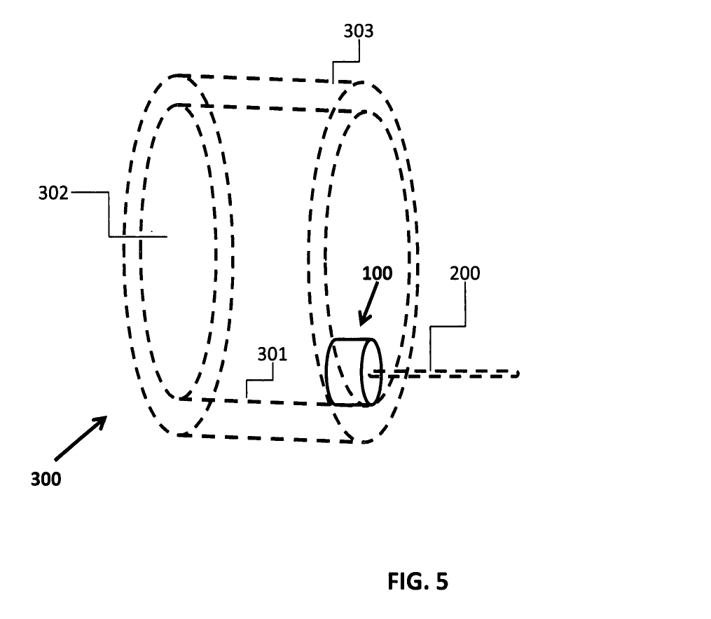

FIG. 5 is perspective of the exemplary embodiment of the wheelmill 100 in conjunction with a vehicle wheel inner rotational wall surface 301.

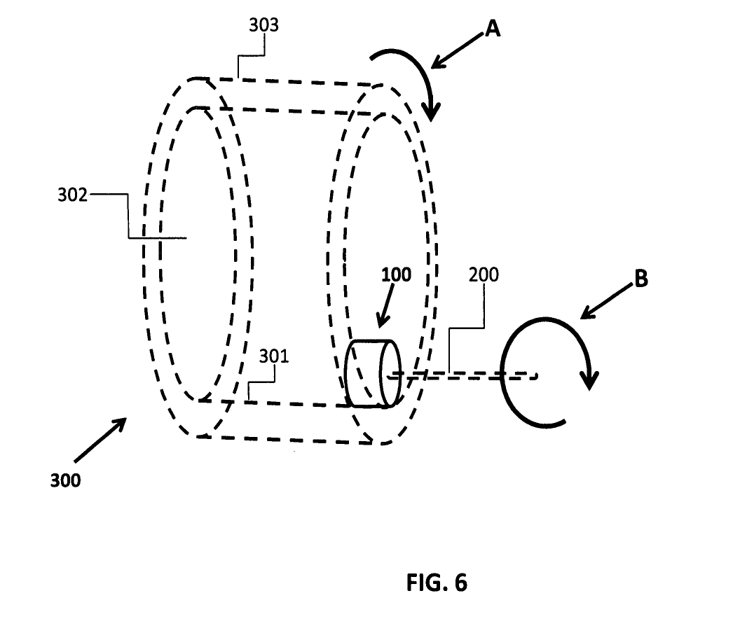

FIG. 6 is perspective of the vehicle wheel 300 in rotation A, yielding rotation B, of the exemplary embodiment of the wheelmill 100.

I claim:

1. A system to transfer vehicle wheel rotation to an electric motor generator, in order to produce electricity for the vehicle, said system comprising; Wheel assembly rotation will spin an electric generator motor by connection between the wheelmill and vehicle wheel assembly. Electricity generated from the wheelmill can be used to supplement and recharge the power of the vehicle's electrical source, lengthen battery life, and minimize battery capacity.

2. The wheelmill of claim 1, wherein said safely works with wheeled vehicles.

3. The wheelmill of claim 1, wherein said transfers the rotation of a vehicle wheel to an electric generator motor.

4. The wheelmill of claim 1, wherein said rotates in conjunction with the wheel assembly of a vehicle.

5. The wheelmill of claim 1, wherein said rotates in conjunction with electric generator motor.

6. The wheelmill of claim 1, wherein said rotates in conjunction with an electric generator motor shaft.

7. The wheelmill of claim 1, wherein the said generates electricity by yielding electric generator motor rotation.

8. The wheelmill of claim 1, wherein is rotated by the vehicle wheel assembly.

9. The wheelmill of claim 1, wherein the said is securely connected to the shaft by complimentary threaded ends.

10. The wheelmill of claim 1, wherein the said is securely connected to the shaft by secure connection.

11. The wheelmill of claim 1, wherein the said is connected in unison with an electric generator motor shaft.

12. The wheelmill of claim 1, wherein the said rotates on a stationary axis.

13. The wheelmill of claim 1, wherein uses an optional gear box to transfer wheel rotation to the angle in which the electric motor is mounted.

14. The wheelmill of claim 1, wherein is comprised of solid material.

15. The wheelmill of claim 1, wherein uses an optional belt to transfer wheel rotation to the angle in which the electric motor is located.

16. The wheelmill of claim 1, wherein said produces electricity for vehicle electrical source supplement.

17. The wheelmill of claim 1, wherein said produces electricity for vehicle electrical source recharge.

18. The wheelmill of claim 1, wherein can be used on wheeled vehicles.

19. The wheelmill of claim 1, wherein provides an efficient way to for wheeled vehicles to produce electricity for its own usage.
